(19) United States
(12) Patent Application Publication
(10) Pub. No.: US 2019/0214701 A1
(43) Pub. Date: Jul. 11, 2019

(54) RETRACTABLE ANTENNA

(71) Applicant: VOXX International Corporation, Hauppauge, NY (US)

(72) Inventors: Prapan Paul Tinaphong, Carmel, IN (US); Chung Hua Hung, Kaohsiung Hsien (TW)

(21) Appl. No.: 16/238,281

(22) Filed: Jan. 2, 2019

Related U.S. Application Data
(60) Provisional application No. 62/614,587, filed on Jan. 8, 2018.

(51) Int. Cl. H01Q 1/12; H01Q 1/08; H01Q 9/04; E06B 9/44

(52) U.S. Cl. CPC H01Q 1/1235; H01Q 1/087; E06B 2009/407; E06B 9/44; H01Q 9/0421

(57) ABSTRACT

A retractable antenna assembly includes a planar antenna and a retraction mechanism. The planar antenna is affixed to the retraction mechanism and is selectively extendable and retractable therefrom. The planar antenna includes an antenna element having one or more antenna element segments. The retraction mechanism includes an elongated main body that is operatively coupled to at least two end brackets that mount the retraction mechanism to a supporting structure. The elongated main body includes a tubular sidewall having an outer surface that defines an interior space in which a cable and a preamplifier circuit are situated.

### CROSS-REFERENCE TO RELATED APPLICATIONS

This application is related to U.S. Provisional Patent Application Ser. No. 62/614,587, filed on Jan. 8, 2018, and entitled “High Gain, Omni-Directional Window Shade Antenna”, the disclosure of which is hereby incorporated by reference and on which priority is hereby claimed.

### BACKGROUND OF THE INVENTION

### Field of the Invention

The present invention generally relates to antennas for receiving broadcast television signals, and more specifically relates to omni-directional antennas for receiving high definition television signals broadcast over the air which are used in residential premises.

### Description of the Prior Art

High gain, omni-directional antennas for receiving high definition television signals broadcast over the air are well known in the art. For example, U.S. Pat. No. 8,269,672, which issued to Prapan Paul Tinaphong, et al., discloses one form of a planar, omni-directional television antenna. Another planar, flexible, high gain, omni-directional television antenna is disclosed in U.S. Pat. No. 9,281,571, which issued to Prapan Paul Tinaphong, et al. The disclosure of each of the aforementioned patents is incorporated herein by reference. The antennas described in these patents work well to receive broadcast high definition television signals in residential premises, apartment buildings and offices. These disclosed antennas, like the antenna of the present invention disclosed herein, overcome the difficulties and inherent disadvantages of traditional indoor television antennas for receiving broadcast television signals, such as the indoor monopole or dipole television antennas (commonly known as “rabbit ear” antennas with telescopic antenna elements).

One of the major problems with indoor television antennas is that the structure of the building or premises diminishes the signal strength of broadcast television signals such that reception of such signals may be poor or non-existent. Accordingly, it would be preferred to locate a broadcast television antenna closer to a window of a residential home in order to receive the strongest signal without any signal reduction resulting from walls or internal building construction material, or anything else that can block reception of television broadcast signals.

One of the problems, though, of placing a television antenna near or on a window is that, oftentimes, it blocks the view out the window even when not in use or may interfere with the window being opened or closed, especially if the antenna is affixed to the window.

### OBJECTS AND SUMMARY OF THE INVENTION

It is an object of the present invention to provide a planar, high gain, omni-directional antenna for receiving high definition television signals broadcast over the air.

It is another object of the present invention to provide a high gain, omni-directional antenna which may be mounted in close proximity to a window of a residential premises for best reception of broadcast television signals.

It is a still another object of the present invention to provide a planar, flexible, high gain, omni-directional antenna for receiving high definition television signals broadcast over the air that is extendable and retractable and mountable in proximity to a window of a residential premises.

It is yet a further object of the present invention to provide an antenna for receiving high definition television signals broadcast over the air that overcomes the inherent difficulties and disadvantages of known broadcast television antennas.

A high gain, omni-directional television antenna constructed in accordance with one form of the present invention takes the form generally of a window shade, and is mountable in proximity to a window and is retractable and extendable thereon, in the same manner as a window shade. The antenna includes antenna elements which are interposed between two layers of fabric that is attached to and rolled onto an elongated, tubular support. The tubular support includes a coiled spring that allows the antenna element, and fabric coverings, to be extended over the window, against the bias of the spring, and retracted to uncover the window, with the assistance of the spring. A pawl and ratchet mechanism attached to one axial end of the elongated tubular member is used to hold the antenna element and fabric coverings in a desired extended position over the window on which it is mounted, just like an ordinary window shade.

The antenna element is connected through a feed connection to a coiled coaxial cable inside the bore of the tubular member on which the antenna element and fabric are rolled. The other end of the connecting cable is coupled to a coaxial connector located at the opposite axial end of the tubular member. An external coaxial cable may be connected to the connector, the opposite end of which may then be connected to a television within the residential premises. An amplifier, in one version of the antenna of the present invention, may be connected in series with the coaxial connector and the external cable extending to the television to provide an amplification of the signal that is received by the window shade antenna of the present invention.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1A is a perspective view of a “window shade antenna” constructed in accordance with one form of the present invention, and shown in an extended state.

FIG. 1B is another perspective view of a window shade antenna formed in accordance with one form of the present invention, and illustrating a mounting fixture for mounting the window shade antenna in proximity to a window.

FIG. 1C is a front view of a window shade antenna formed in accordance with the present invention, and shown in an extended state, as well as a mounting fixture for the antenna.

FIG. 1D is a top plan view of the window shade antenna and mounting fixture of the present invention shown in FIG. 1C.

FIG. 1E is a side elevational view of the window shade antenna and mounting fixture of the present invention shown in FIG. 1C.

FIG. 1F is a front view of the window shade antenna and mounting fixture therefor of the present invention, the antenna being shown in a retracted state.

FIG. 1G is a front view of the shade portion of the window shade antenna of the present invention, and illustrating the antenna element or elements thereof sandwiched between two layers of window shade fabric.

FIG. 1H is a perspective view of the shade portion of the window shade antenna of the present invention, and illustrating the layers of fabric of which the shade portion is formed.

FIG. 1I is a top plan view of an amplifier and coaxial cables used in connection with the window shade antenna of the present invention.

FIG. 1J is a cross-sectional view of one form of the window shade antenna of the present invention, and illustrating components of the antenna which allow the shade portion of the antenna to be extended and retracted.

FIG. 1K is another cross-sectional view of one form of the window shade antenna of the present invention, and illustrating components of the antenna which allow the shade portion of the antenna to be extended and retracted.

FIG. 2 is a plan view of a first form of an antenna element or elements forming part of the window shade antenna of the present invention.

FIG. 3 is a perspective view of the antenna element or elements of the window shade antenna of the present invention shown in FIG. 2.

FIG. 4 is a chart of voltage standing wave ratio (VSWR) relating to the antenna element or elements of the window shade antenna of the present invention shown in FIGS. 2 and 3.

FIG. 5 is a Smith chart and impedance table related to the antenna element or elements of the window shade antenna of the present invention shown in FIGS. 2 and 3.

FIGS. 6A-6I are radiation patterns at various frequencies relating to the antenna element or elements of the window shade antenna of the present invention shown in FIGS. 2 and 3.

FIG. 7 is a gain graph in decibels versus frequency related to the antenna element or elements of the window shade antenna of the present invention shown in FIGS. 2 and 3.

FIG. 8 is a plan view of a second form of an antenna element or elements forming part of the window shade antenna of the present invention.

FIG. 9 is a perspective view of the antenna element or elements of the window shade antenna of the present invention shown in FIG. 8.

FIG. 10 is a chart of voltage standing wave ratio (VSWR) relating to the antenna element or elements of the window shade antenna of the present invention shown in FIGS. 8 and 9.

FIG. 11 is a Smith chart and impedance table related to the antenna element or elements of the window shade antenna of the present invention shown in FIGS. 8 and 9.

FIGS. 12A-12I are radiation patterns at various frequencies relating to the antenna elements or elements of the window shade antenna of the present invention shown in FIGS. 8 and 9.

FIG. 13 is a gain graph in decibels versus frequency related to the antenna element or elements of the window shade antenna of the present invention shown in FIGS. 8 and 9.

FIG. 14 is a plan view of a third form of an antenna element or elements forming part of the window shade antenna of the present invention.

FIG. 15 is a perspective view of the antenna element or elements of the window shade antenna of the present invention shown in FIG. 14.

FIG. 16 is a chart of voltage standing wave ratio (VSWR) relating to the antenna element or elements of the window shade antenna of the present invention shown in FIGS. 14 and 15.

FIG. 17 is a Smith chart and impedance table related to the antenna element or elements of the window shade antenna of the present invention shown in FIGS. 14 and 15.

FIGS. 18A-18I are radiation patterns at various frequencies relating to the antenna elements or elements of the window shade antenna of the present invention shown in FIGS. 14 and 15.

FIG. 19 is a gain graph in decibels versus frequency related to the antenna element or elements of the window shade antenna of the present invention shown in FIGS. 14 and 15.

### DETAILED DESCRIPTION OF THE PREFERRED EMBODIMENTS

Generally, and as may be seen from the drawings, the antenna 2 of the present invention is formed as a window shade that may be mounted in a window of a residential premises and is retractable and extendable over the window, just like a conventional window shade. The antenna element or elements forming the window shade antenna 2 of the present invention provide a high gain, omni-directional, flexible, planar antenna for receiving high definition television signals that are broadcast over the air.

Many forms and constructions of antenna elements have been tested by the inventors herein, and durability and stability, as well as low impedance, of the conductive antenna elements, and the aesthetics of the window shade antenna 2, are primary concerns and must be addressed in the development of the antenna of the present invention. In one form of the present invention, silver conductive ink is pasted on a fabric sheet material acting as a window shade, in a manner similar to applying a silk screen on a fabric. In another embodiment of the present invention, a conductive copper tape is used that adheres directly onto a fabric sheet material.

However, it has been found by the inventors that the use of nickel (Ni) and copper (Cu), in combination with a polyester fabric, creates a conductive woven fabric 4 that forms the antenna elements of the window shade antenna 2. This material may be rolled in and out as a window shade with substantially unlimited times of usage. The special conductive woven strip fabric 4 is sewed or glued onto a layer of window shade fabric 6, such as cotton cloth or polyester material, on one side, and on the other side is another layer 8 of the same type of fabric to cover and protect the conductive antenna elements. This is the preferred form of the window shade antenna 2 of the present invention. Thus, the antenna elements will be situated between two layers 6,8 of the fabric, the combination of which acts as a conventional window shade in that it may be retracted and extended over a window on which it is mounted. The preferred conductive fabric material 4 used to form the antenna elements of the window shade antenna 2 of the present invention is Part No. MC000011 manufactured by Shenzhen Hong Fu Cheng Shielding Materials Co., Ltd., of C Building 1-3 Floors, Phoenix Third Industrial Zone 0A-04 Zone, Fuyong Street, Bao'an District, Shenzhen City, China. Thus, the fabric antenna elements 4, sandwiched between two protective fabric coverings 6,8, constitute the “shade” portion of the window shade antenna 2 of the present invention.

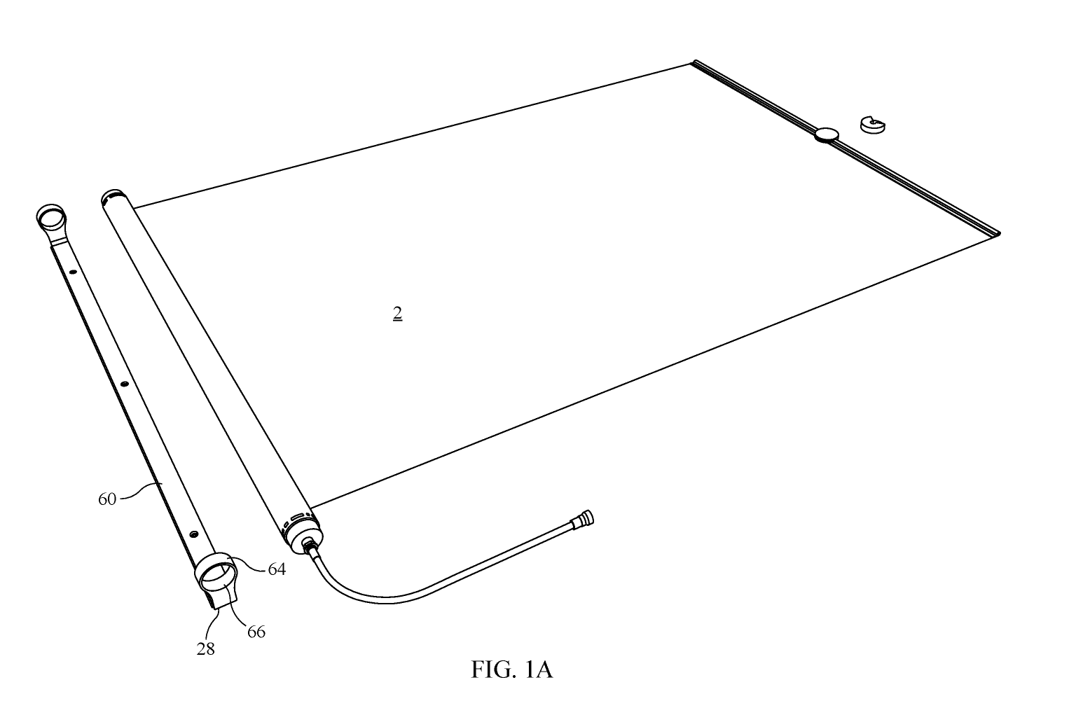

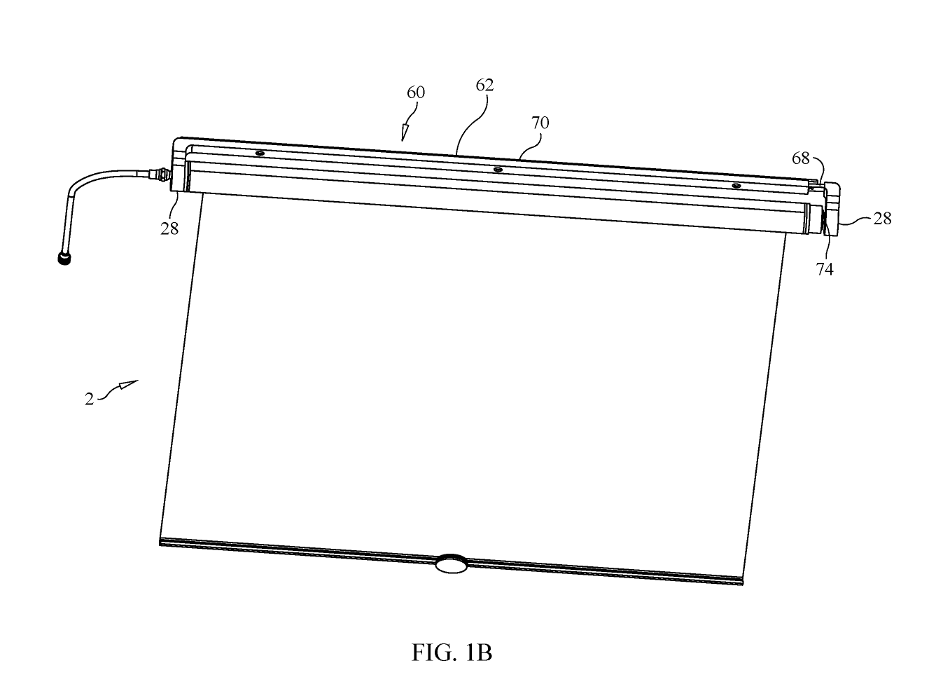

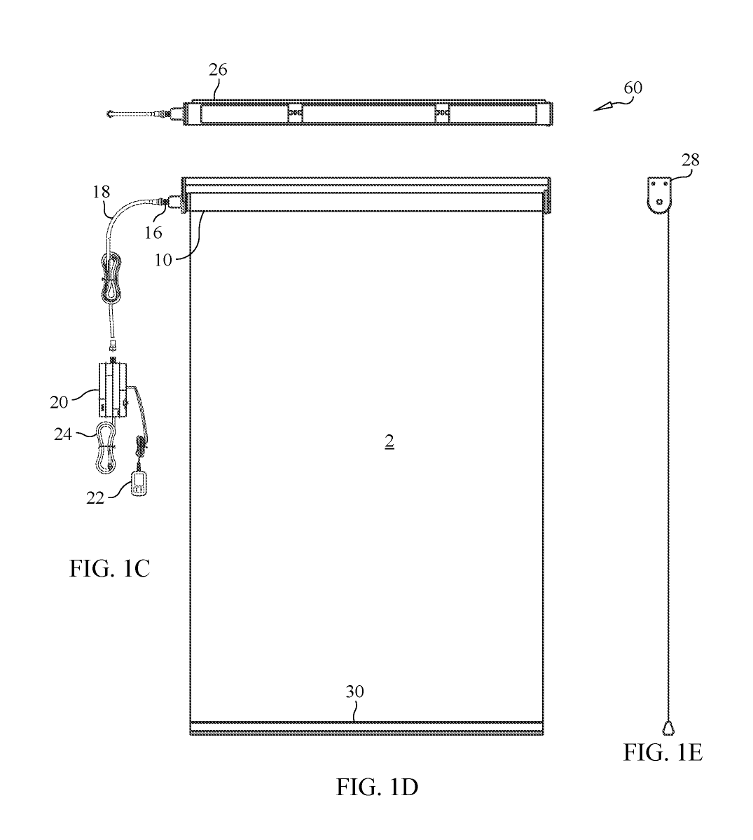

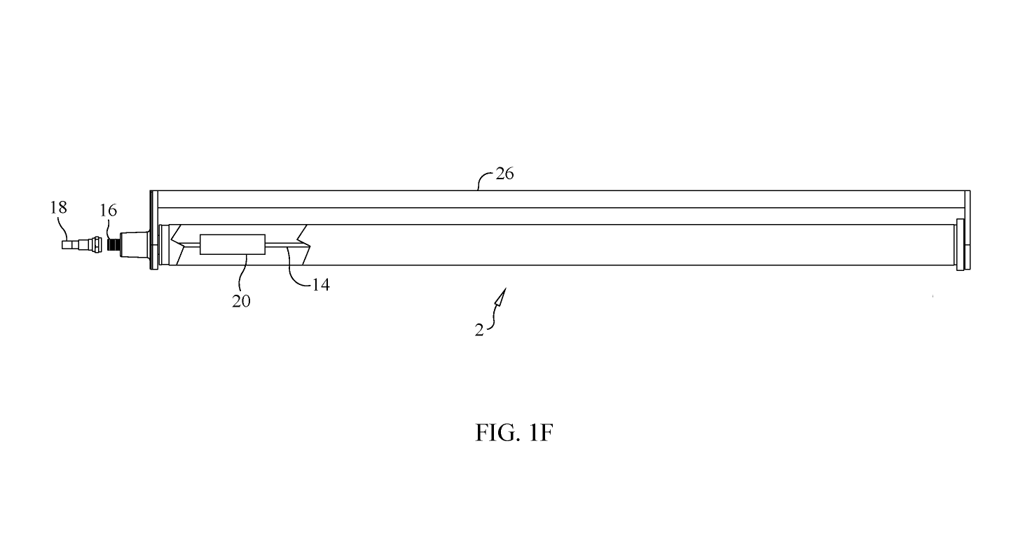

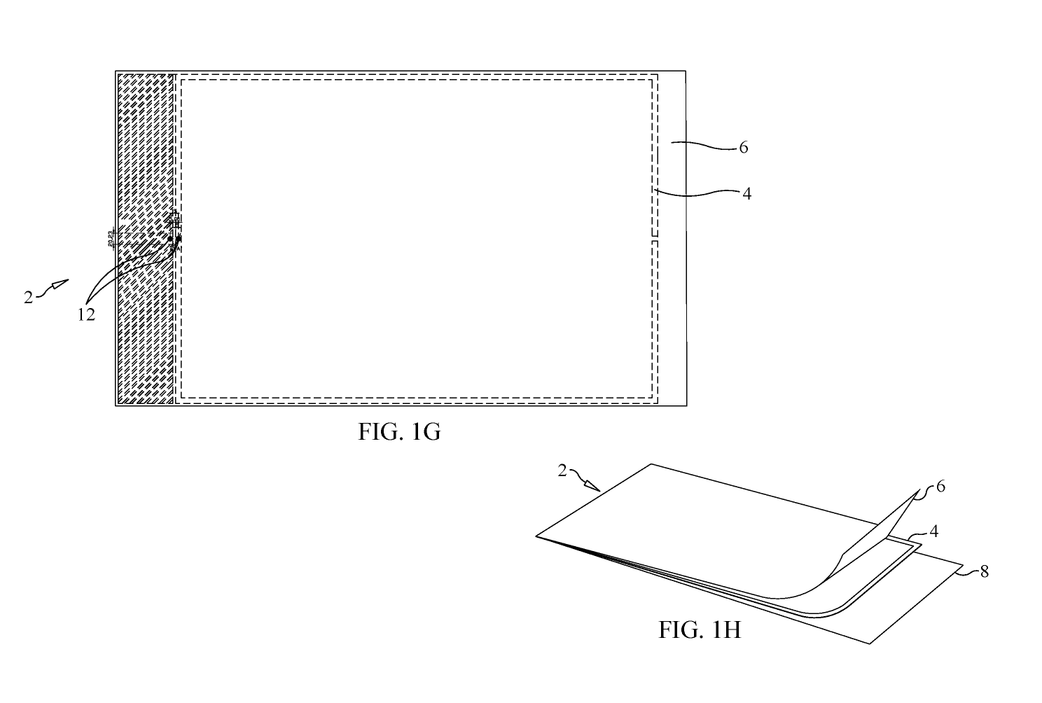

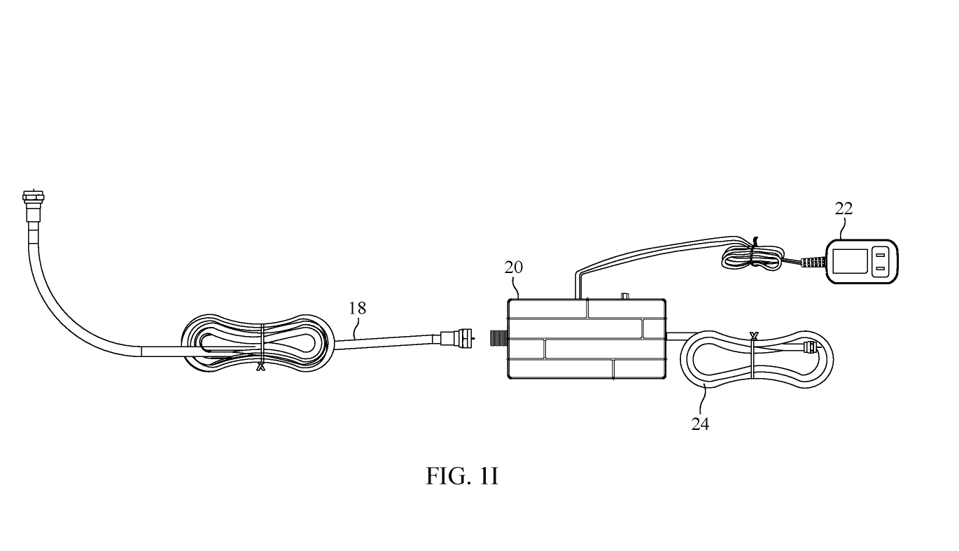

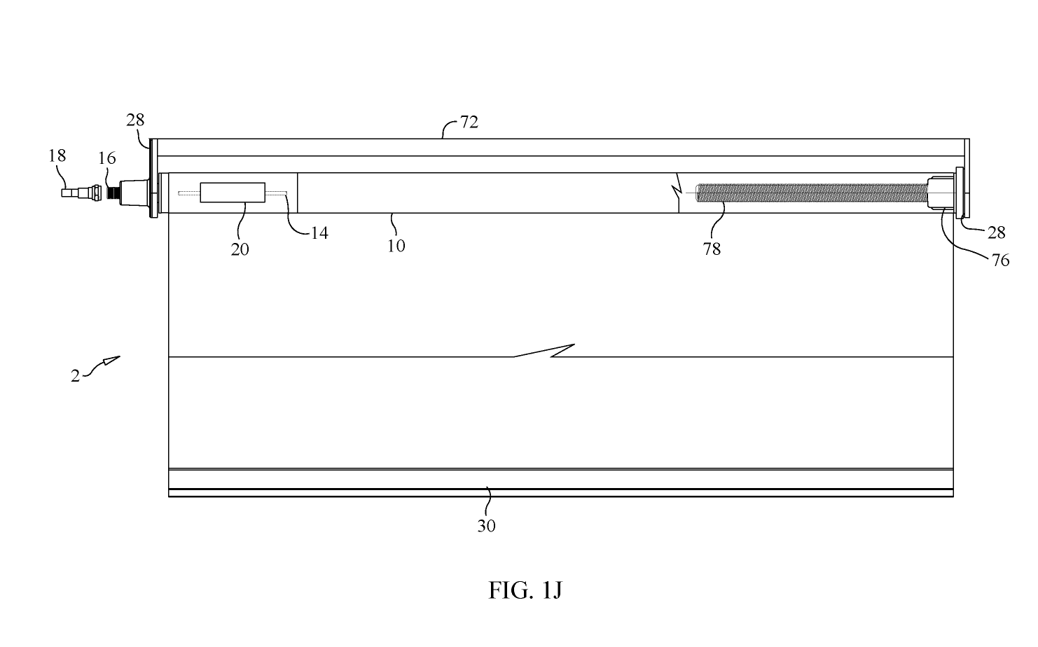

The upper end of this shade portion is affixed to the outer surface of an elongated, tubular member 10 having an axial bore extending therethrough. The feed point 12 of the antenna elements is connected to one end of a flexible coaxial cable 14 located inside the bore of the elongated, tubular member 10. The other end of this coaxial cable 14 is connected to, preferably, an F-type coaxial connector 16 situated on one axial end of the elongated, tubular member 10, as shown in FIG. 1F of the drawings. An external coaxial cable 18, preferably between about 19 feet and about 25 feet in length, is further provided, and is connectable to the axially mounted coaxial connector 16 and to the signal input connector of a television or monitor, in order to provide broadcast television signals received by the window shade antenna 2 of the present invention to the television. Alternatively, the external cable 16 may be connected to one input of a pre-amplifier unit 20, powered by an AC-DC adaptor 22, whose output may be connected to another coaxial cable 24 that is coupled to the television so that the broadcast signals received by the window shade antenna 2 will be amplified prior to being provided to the signal input connector of the television. Alternatively, a pre-amplifier circuit 20 mounted on a printed circuit board may be situated within the bore of the elongated, tubular member 10, and connected to and interposed between the internal flexible coaxial cable 14 and the coaxial connector 16, as shown in FIG. 1J of the drawings.

The window shade antenna 2 of the present invention, as stated previously, and in particular the shade portion thereof, having the antenna elements within the protective coverings 6,8, is retractable and extendable from the elongated, tubular member 10 to cover and uncover a window, just like a conventional window shade. Thus, the window shade antenna 2 of the present invention includes mounting means 26, such as end brackets 28, which hold the axial ends of the elongated, tubular member 10 and allow the tubular member 10 to rotate thereon, the mounting brackets 28 being provided to mount the window shade antenna 2 in proximity to a window. Furthermore, as with a conventional window shade, the window shade antenna 2 of the present invention includes a coiled spring mounted on or within at least one axial end of the elongated, tubular member 10, and a spring biased pawl and ratchet mechanism to retain the window shade antenna 2 in a retracted or extended position as desired by the user. Alternatively, the window shade antenna 2 of the present invention may be mounted within an elongated cabinet having mounting brackets affixed thereto such that the window shade antenna 2, and the cabinet in which it is mounted, may be secured to wall structure surrounding the window. The shade portion of the window shade antenna 2, near its lower end, may include a bottom rail 30 extending laterally across the shade portion, which rail 30 may be grasped by a user in order to retract or extend the shade portion to a desired length. The coaxial cable 14 situated within the bore of the elongated, tubular member 10 between the feed point 12 of the antenna element or elements and the coaxial connector 16 may be pre-coiled so that it may be uncoiled without kinking as the shade portion of the window shade antenna 2 is pulled downwardly to an extended state.

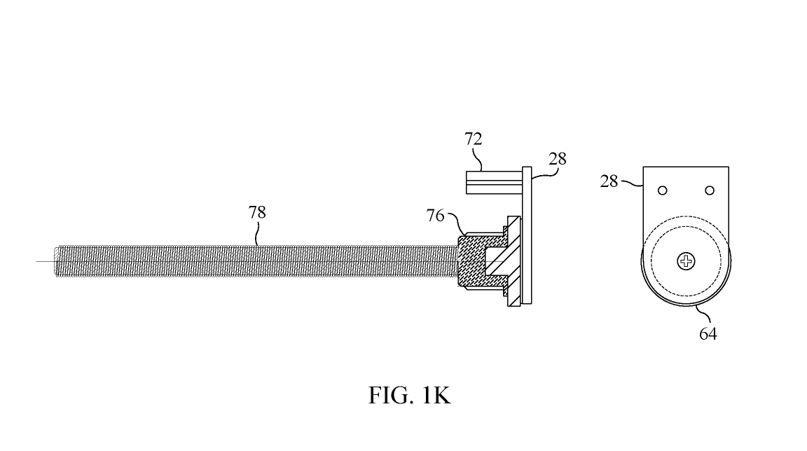

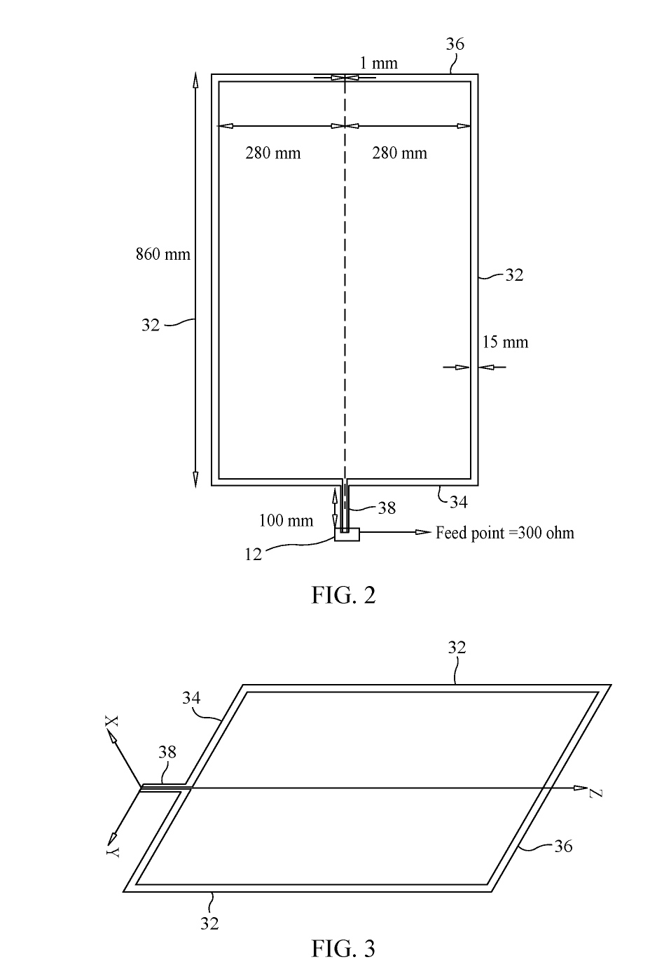

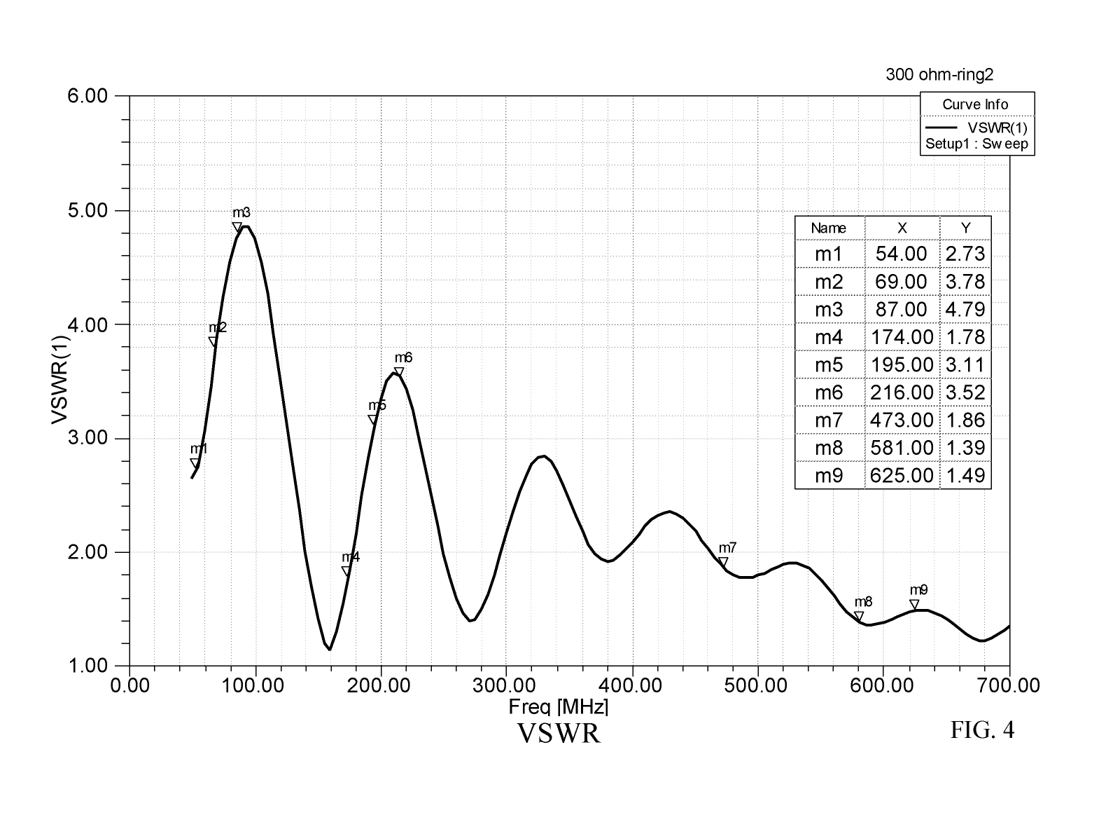

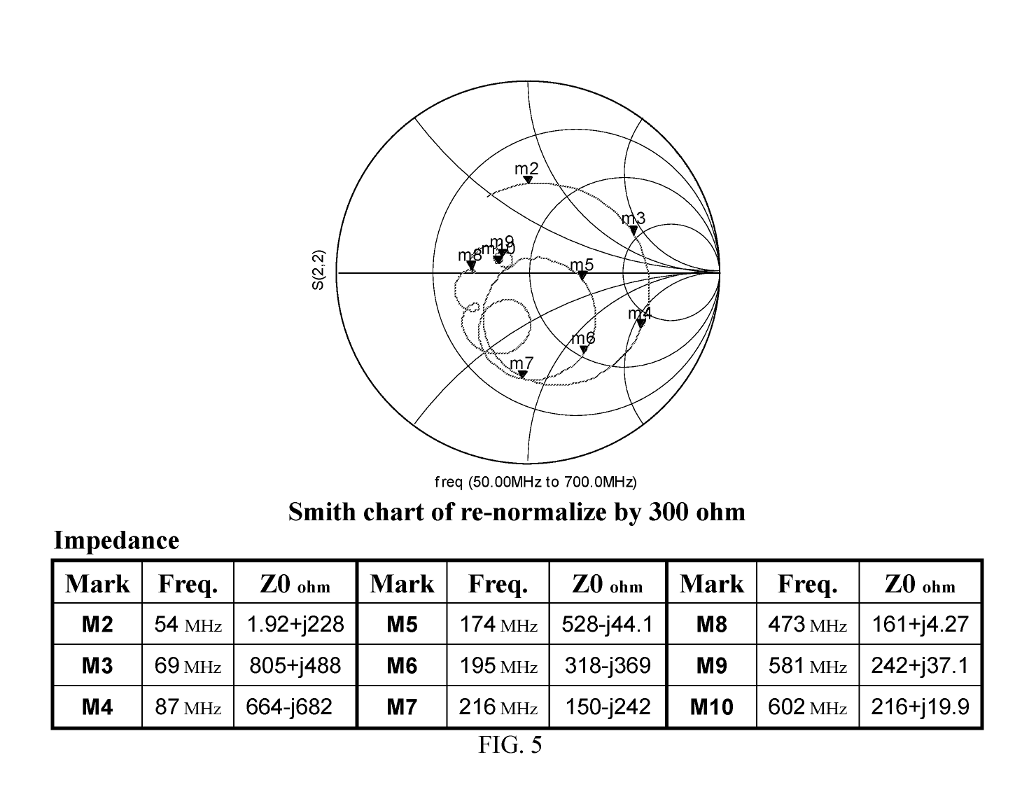

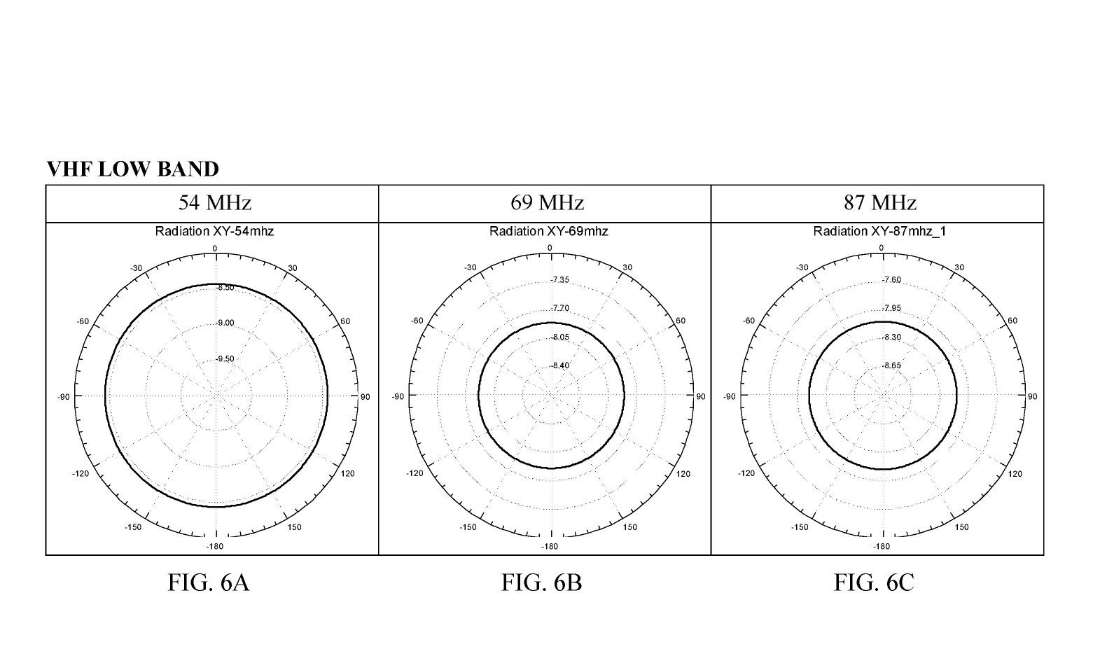

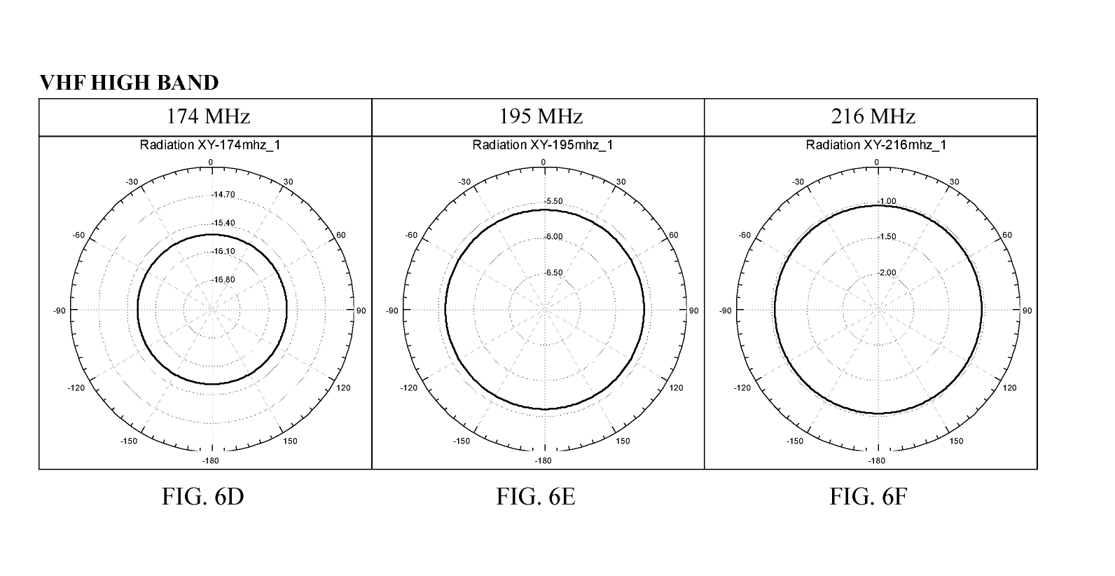

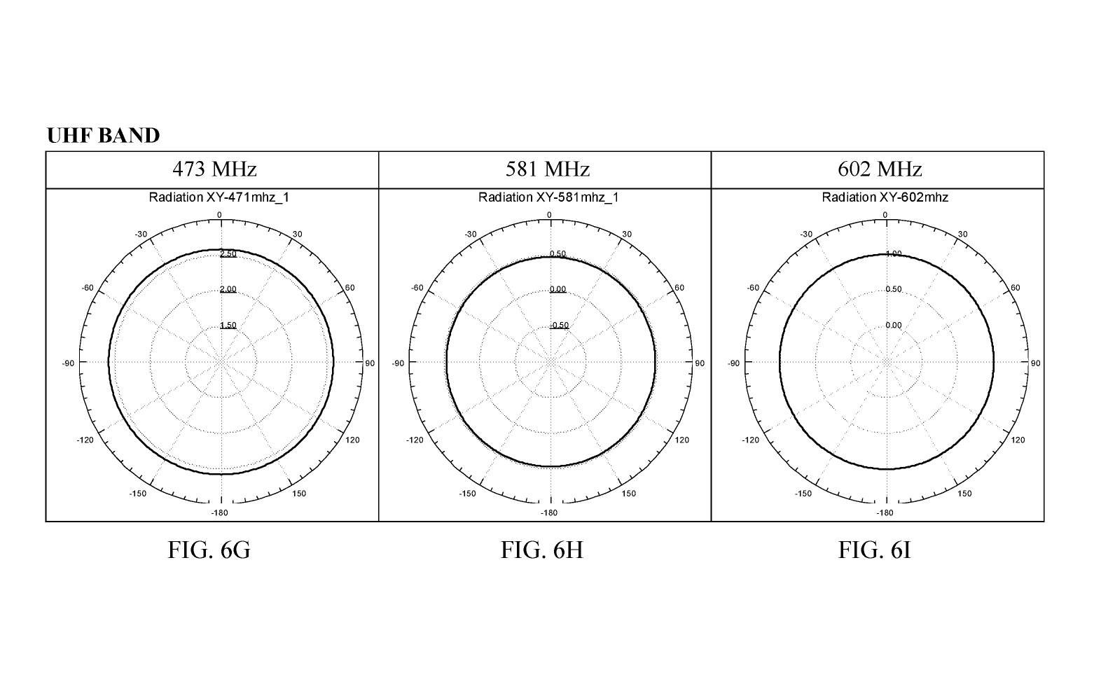

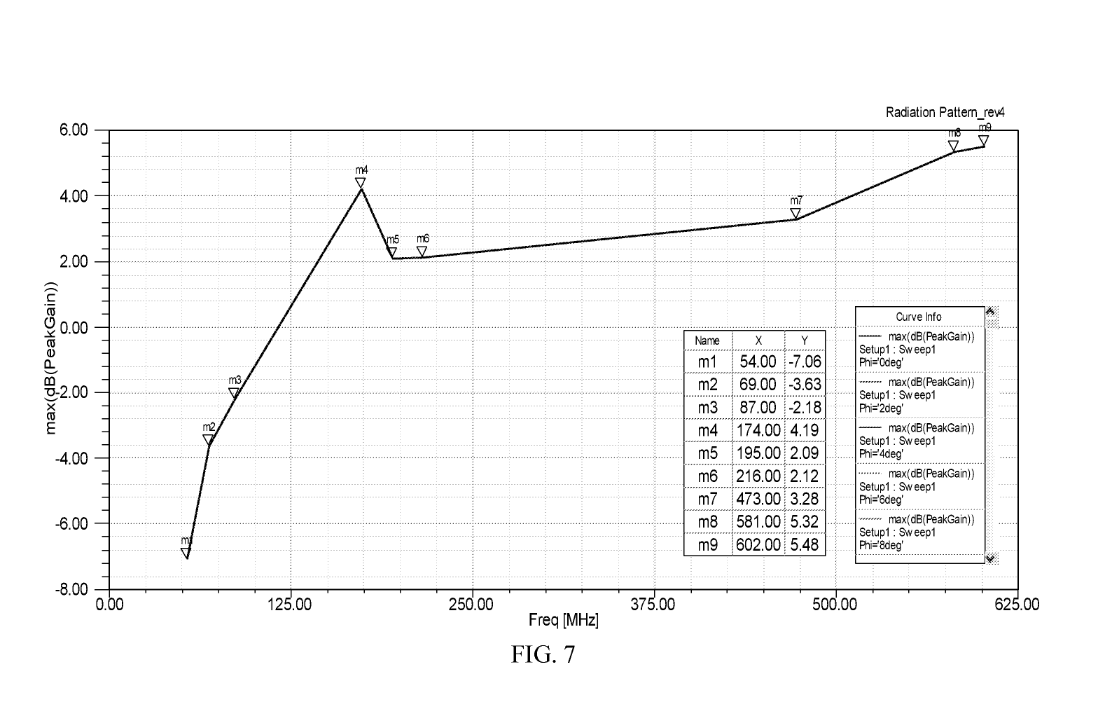

There are several preferred forms of antenna elements which may be used in the window shade antenna 2 of the present invention. In a first preferred form, as shown in FIGS. 2 and 3 of the drawings, the antenna element or elements define a rectangular loop antenna. The loop antenna includes two parallel, spaced apart, side antenna element segments 32, each segment 32 being preferably about 860 millimeters in length, a top antenna element segment 34 interconnecting at their top portions the two spaced apart, side antenna element segments 32 of preferably about 560 millimeters in length, and a bottom antenna element segment 36 interconnecting at their bottom portions the two spaced apart, side antenna element segments 32, the bottom antenna element segment 36 also being preferably about 560 millimeters in length. The feed point 12 of the antenna element, which is about 300 ohms in impedance, is tapped off the top antenna element segment 34 at a central point thereon and connected to the tap point by a length of conductive element material 38 of about 100 millimeters. The width of each of the side antenna element segments 32 and the top and bottom antenna element segments 34,36 is preferably about 15 millimeters, and the thickness of the antenna element segments 32-36 all around is about 1 millimeter. The electronic characteristics of this form of antenna element or elements are shown in FIGS. 4, 5, 6A-6I and 7 of the drawings.

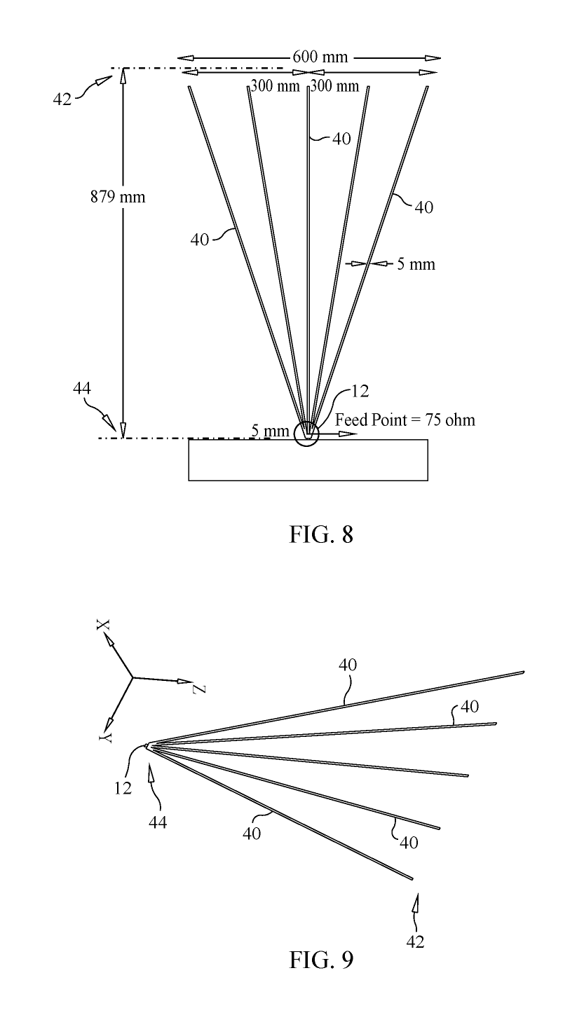

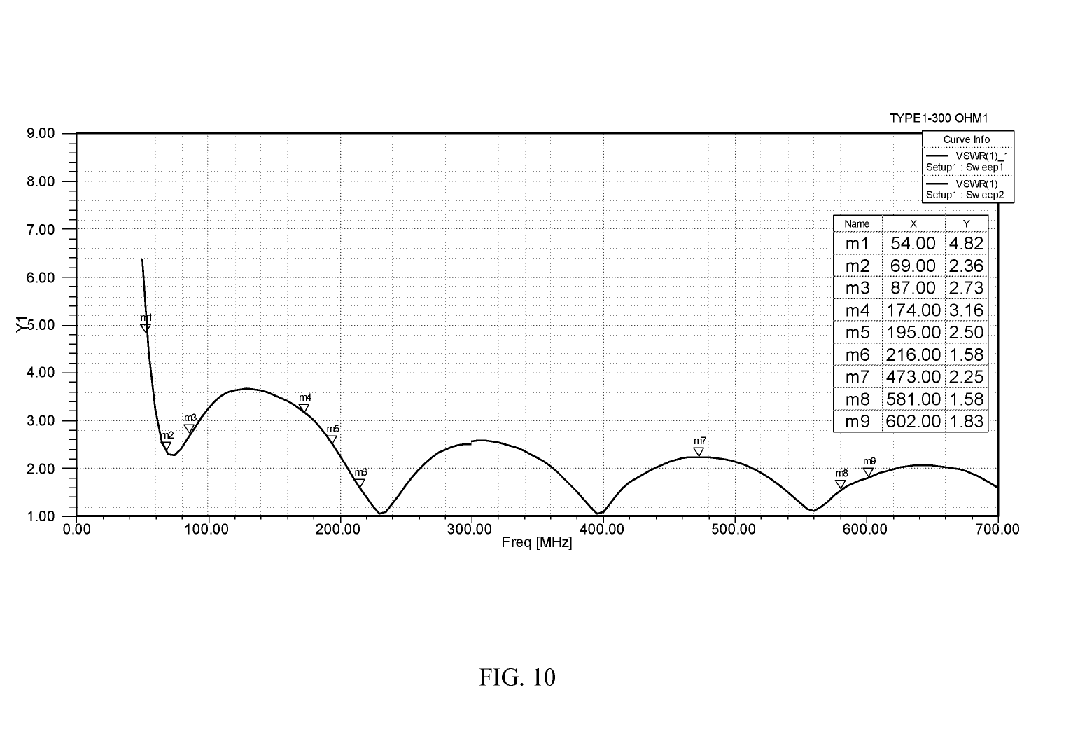

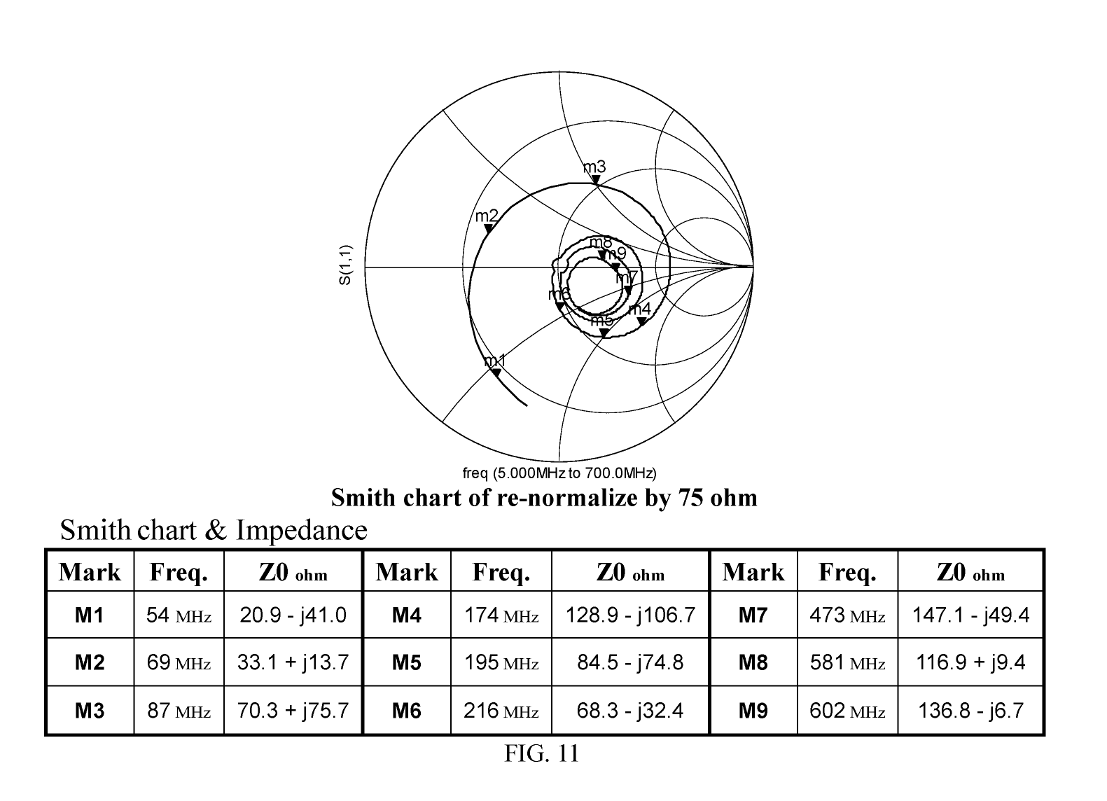

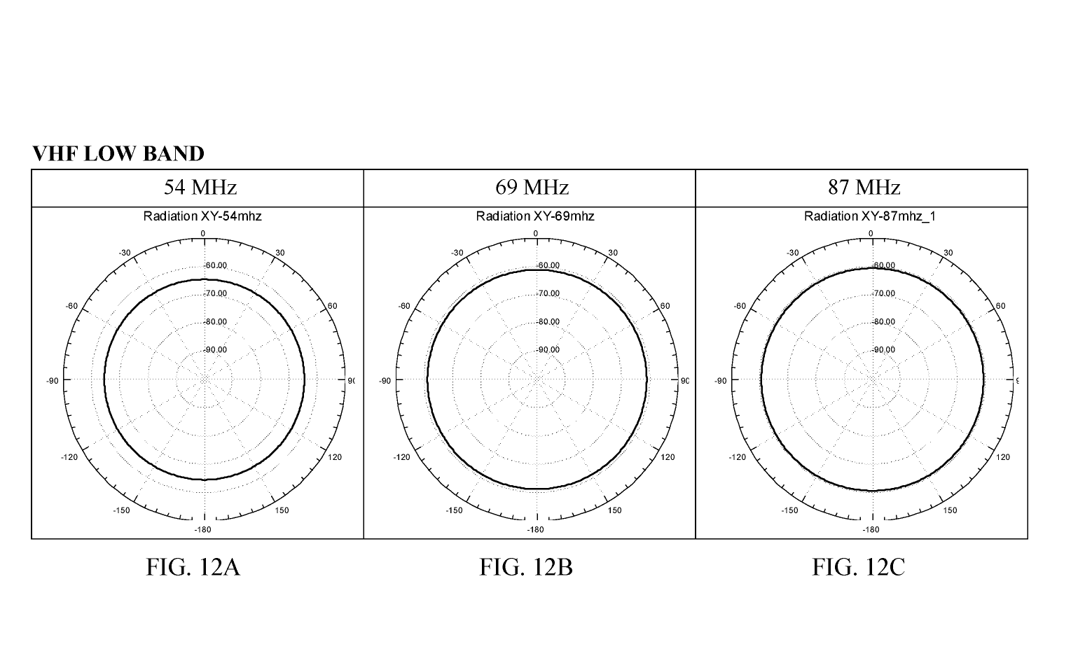

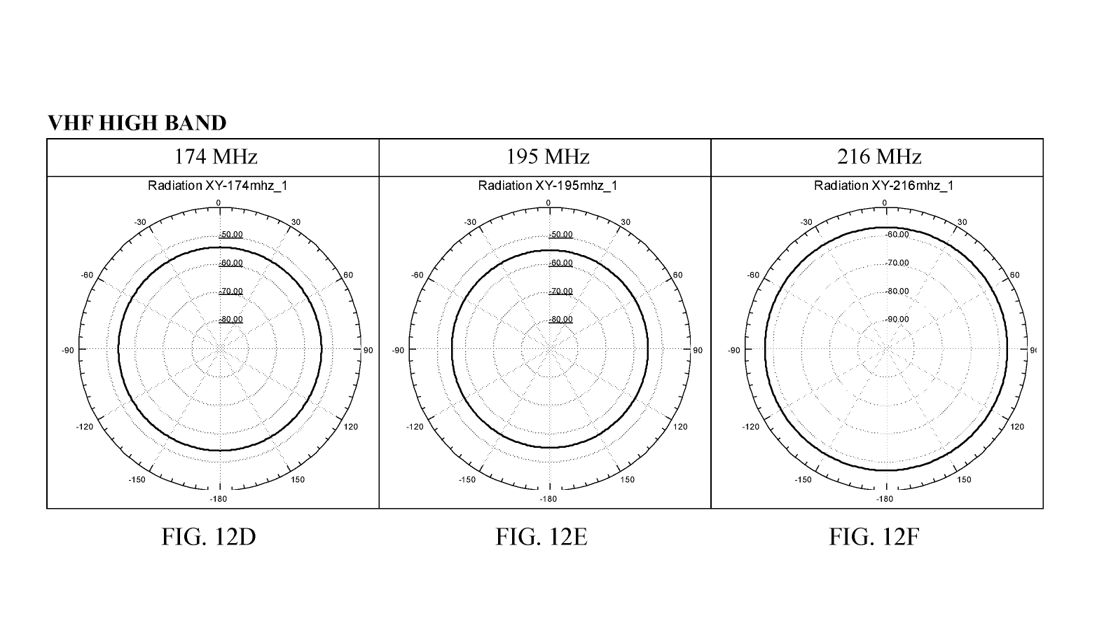

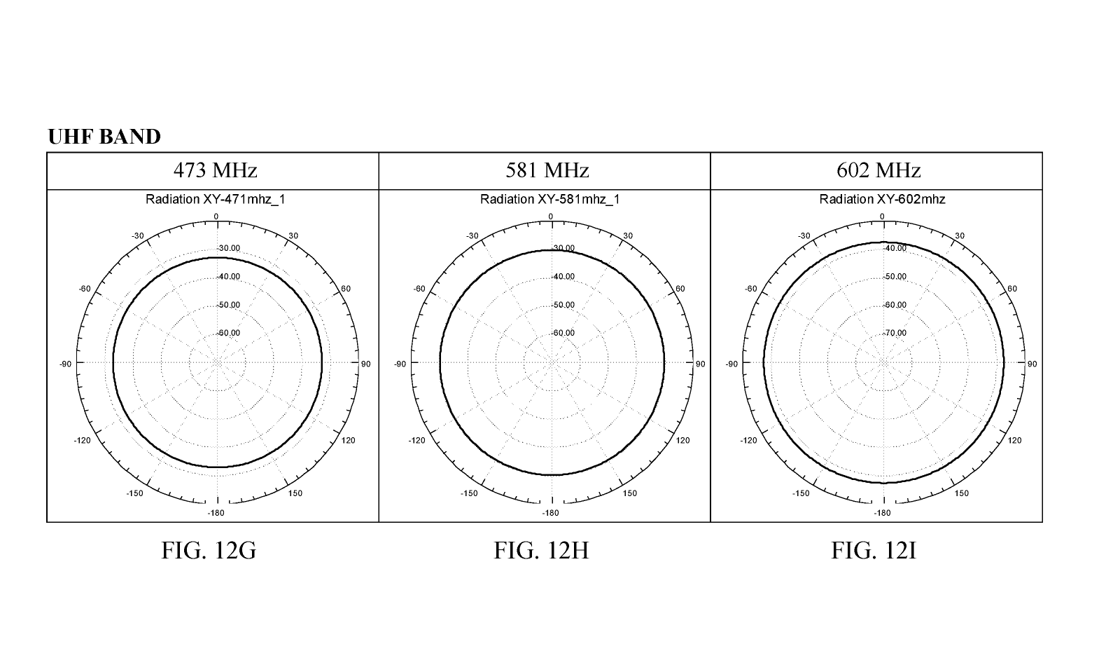

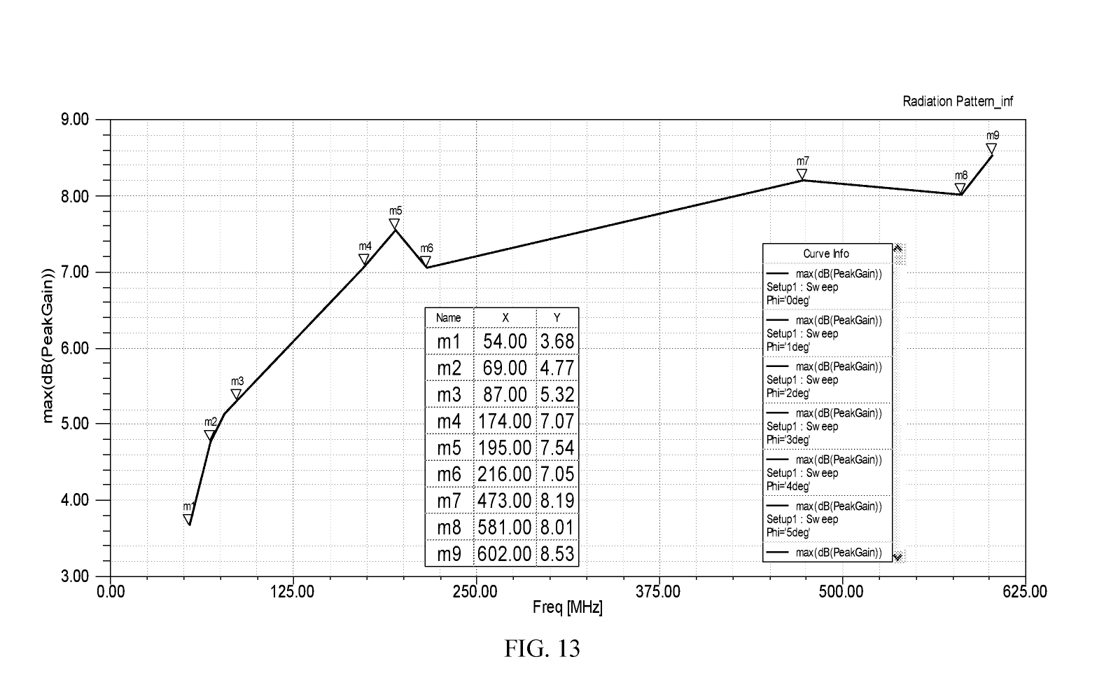

A second preferred form of an antenna element or elements of the window shade antenna 2 of the present invention is shown in FIGS. 8 and 9 of the drawings. A series of angularly extending, spaced apart antenna element segments 40 which converge to a central feed point 12 is included in this design. Preferably, there are five antenna element segments 40, each antenna element segment 40 having a width of about five millimeters. The five antenna element segments 40 are arranged in mirror image on lateral sides of a longitudinally extending centerline of the shade portion, with one antenna element segment 40 occupying the centerline. The antenna element segments 40 are spaced apart at the bottom 42 of the shade portion of the window shade antenna 2 a horizontal total length of about 600 millimeters and define a triangular shape by converging to a central feed point 12, which is about 300 ohms in impedance, on the top 44 of the shade portion of the window shade antenna 2 at an apex of the triangular shape. Preferably, the antenna element segments 40 extend over a vertical total length of about 879 millimeters, from their lower end to the apex or feed point 12 at their upper end. The electronic characteristics of this second form of antenna element or elements of the window shade antenna 2 of the present invention are shown in FIGS. 10, 11, 12A-12I and 13 of the drawings.

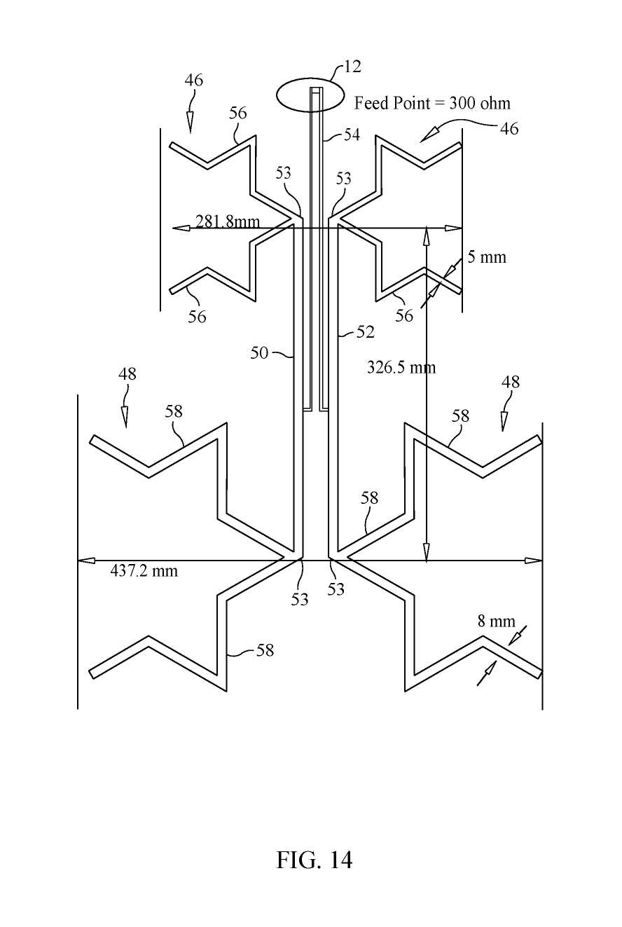

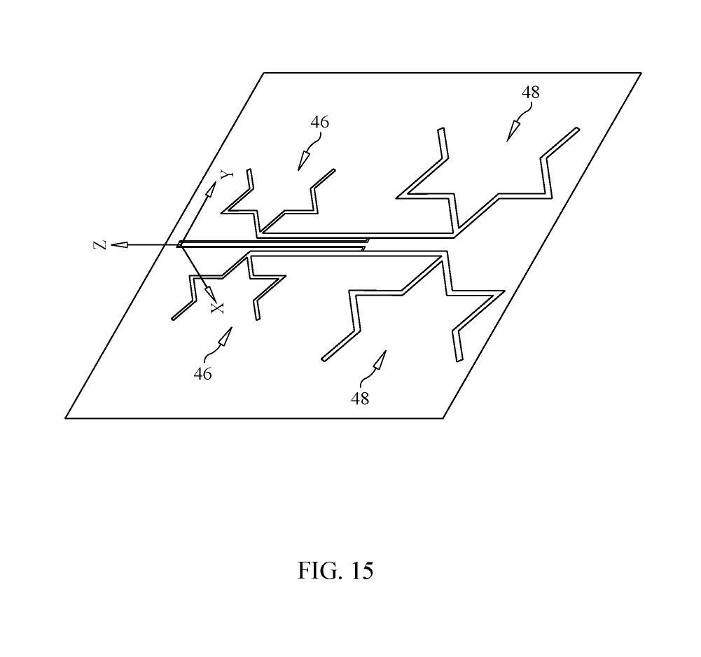

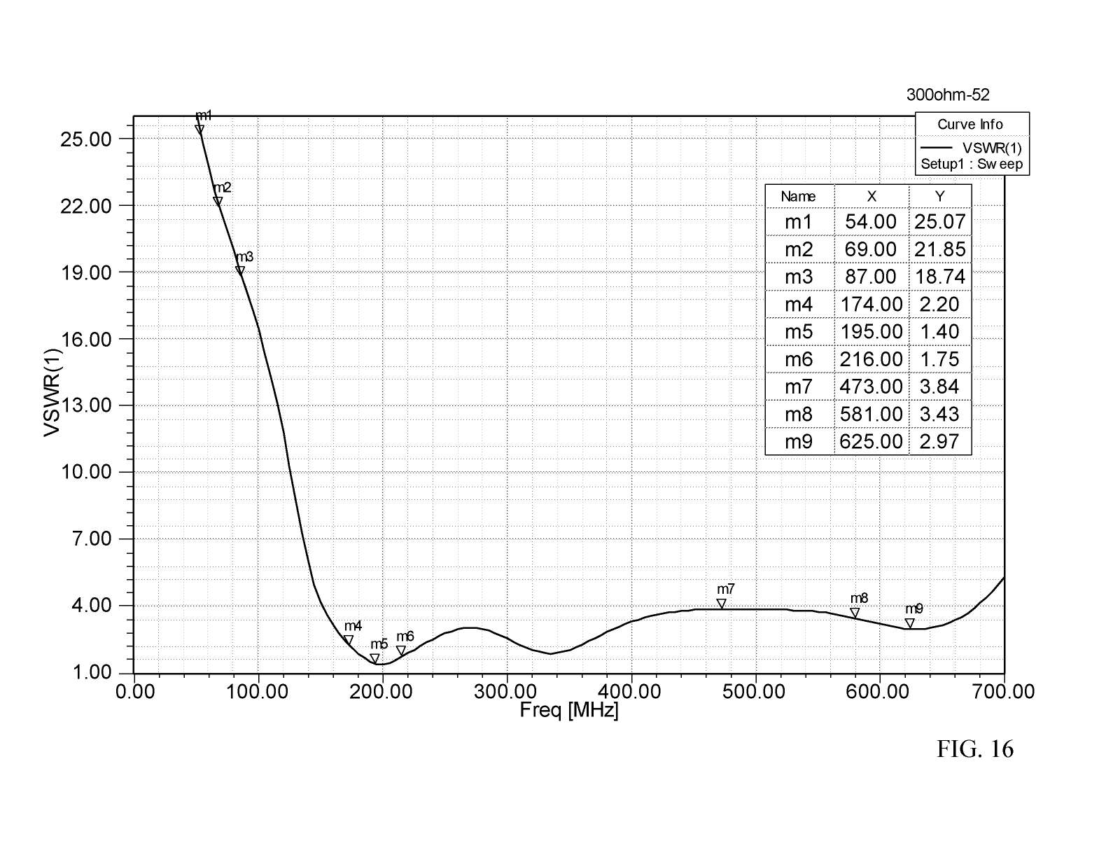

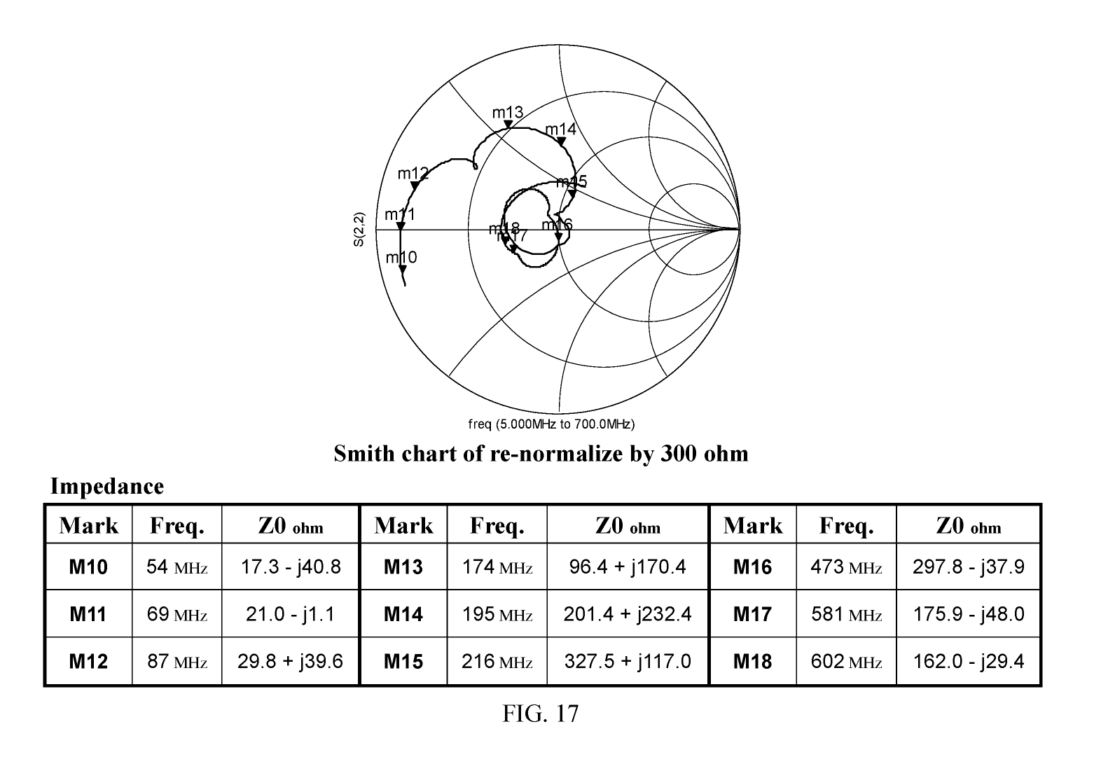

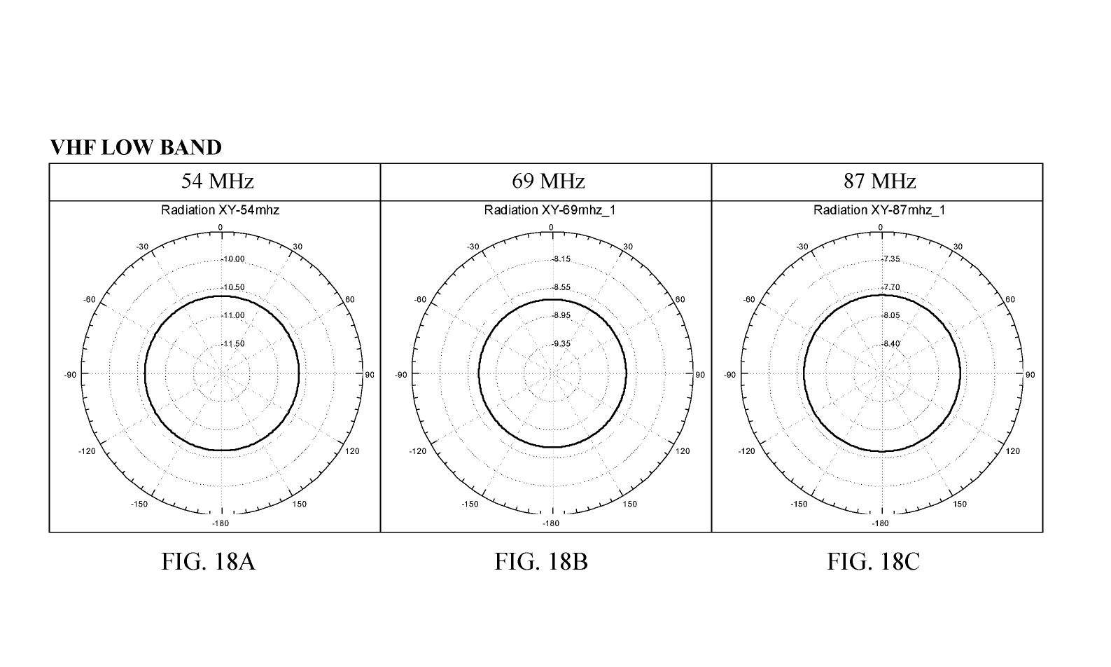

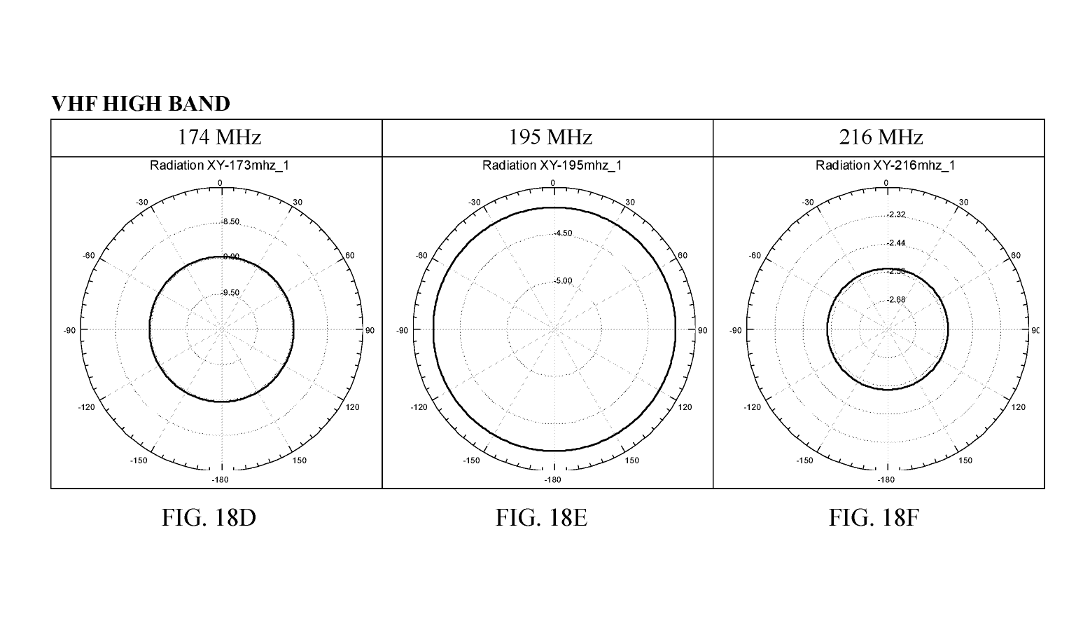

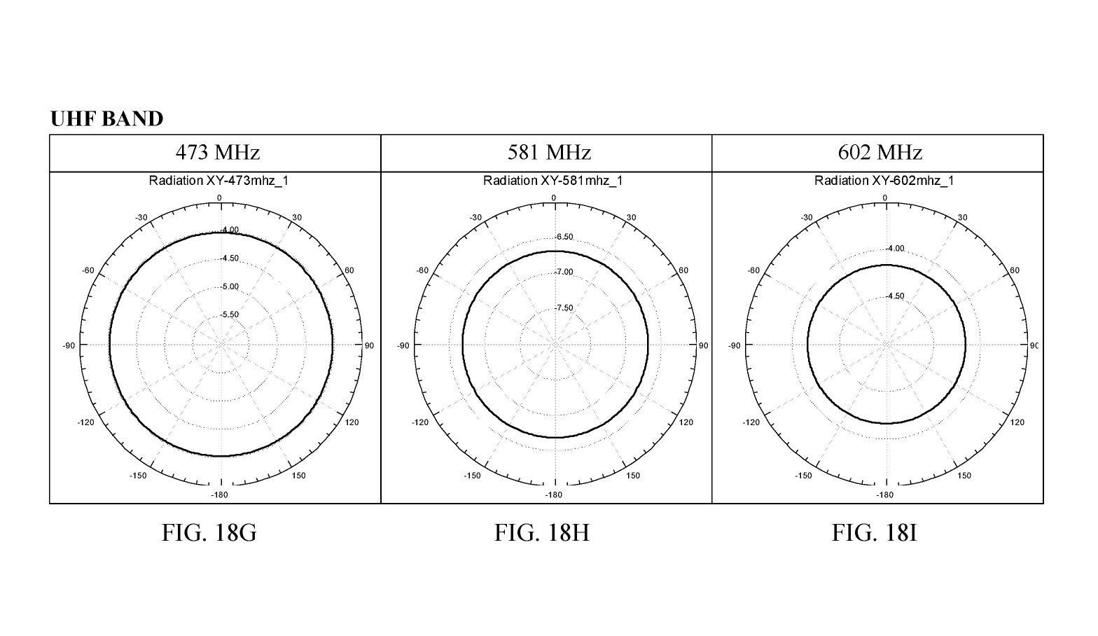

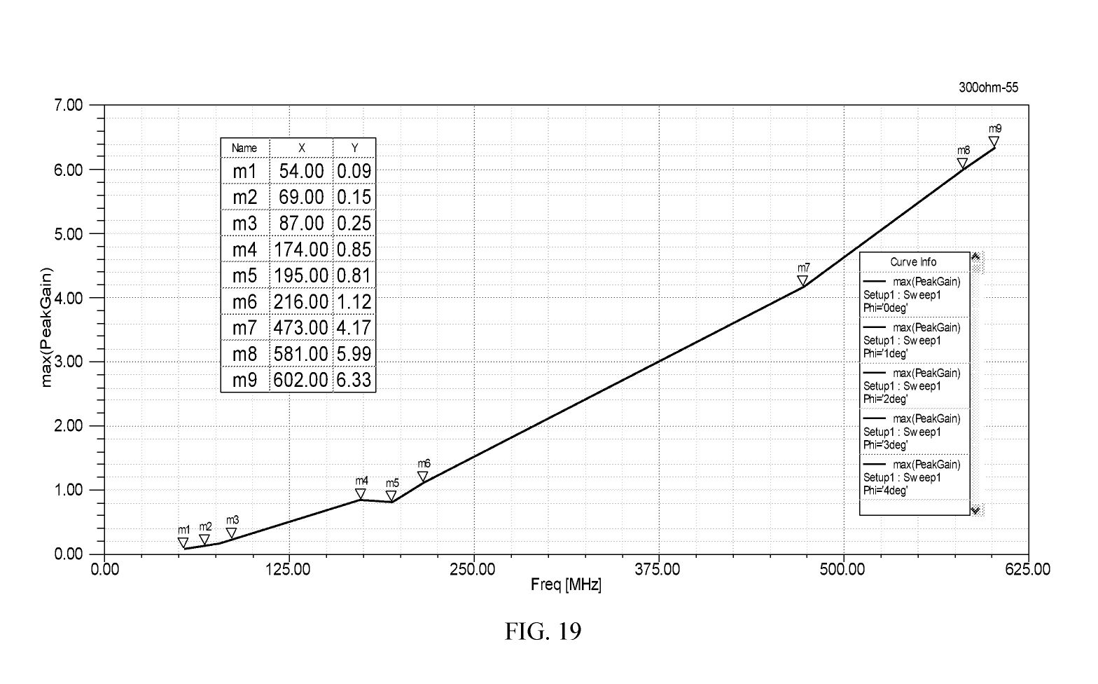

A third preferred form of the antenna element or elements forming part of the window shade antenna 2 of the present invention is shown in FIGS. 14 and 15 of the drawings. This “fractal” antenna element design includes a pair of upper, semi-complete, generally star-shaped antenna element patterns 46 and a pair of lower, semi-complete, generally star-shaped antenna element patterns 48. The upper antenna element patterns 46 are smaller than the lower antenna element patterns 48 in overall dimensions. One upper, star-shaped antenna element pattern 46 and one lower, star-shaped antenna element pattern 48 are situated on one lateral side of the longitudinal centerline of the shade portion of the window shade antenna 2, and the other upper, star-shaped antenna element pattern 46 and the other lower, star-shaped antenna element pattern 48 are situated on the other lateral side of the longitudinal centerline of the shade portion of the window shade antenna 2. The upper and lower antenna element patterns 46,48 on one lateral side of the shade portion are interconnected by a conductive strip of material 50, and the upper and lower antenna patterns 46,48 located on the other lateral side of the shade portion are also interconnected by a conductive strip of material 52. The interconnection points 53 between the upper and lower star-shaped antenna elements 46,48 are spaced apart about 326.5 millimeters in length. The centers of these elongated, interconnecting conductive strips 50,52 are connected to a feed line 54 that extends to a feed point 12 at the upper end of the shade portion of the window shade antenna 2, which feed point 12, like the other antenna elements described previously, is about 300 ohms in impedance.

Each segment 56 forming the upper star-shaped antenna elements 46 is preferably about five millimeters in width, and each segment 58 forming the lower star-shaped antenna elements 48 is about eight millimeters in width. The total horizontal width of the pair of upper star-shaped antenna elements 46 is about 281.8 millimeters, and the total horizontal width of the pair of lower star-shaped antenna elements 48 is about 437.2 millimeters. The electronic characteristics of this fractal antenna element design are shown in FIGS. 10, 11, 12A-12I and 13 of the drawings.

A preferred form of a mounting assembly 60 for mounting the window shade antenna 2 of the present invention to a window frame is shown in FIGS. 1A-1F of the drawings. The mounting assembly 60 includes two, spaced apart, axial end brackets 28 and a transverse, extendable intermediate bracket 62 whose opposite axial ends are connected to the end brackets 28.

Each end bracket 28 is formed with a circular collar 64 defining a central opening 66 axially therethrough, which receives one axial end of the elongated, tubular member 10 about which the shade portion of the window shade antenna 2 is rolled. The transverse, extendable intermediate bracket 62 is preferably formed of two telescopic members—an inner member 68 and an outer member 70 having a bore which receives the inner member 68. The outer member 70 at one axial end of the transverse, intermediate bracket 62 is affixed to one end bracket 28, while the inner member 68 of the other axial end of the transverse, intermediate bracket 62 is affixed to the other end bracket 28.

The transverse, intermediate bracket 62 is spring loaded and extendable, meaning that the inner member 68 of the transverse, intermediate bracket 62 is attached to the outer member 70 through a compression spring so that the inner member 68 may be extended axially out of the open end of the bore of the outer member 70 against the bias of the spring. Such a mechanism is provided to allow the shade portion of the window shade antenna 2 to be easily mounted to and removed from the mounting assembly 60.

One axial end of the elongated, tubular member 10 on which the shade portion is rolled is received in the opening 66 of the collar 64 of one end bracket 28. On the other axial end of the mounting assembly 60, the inner member 68 of the transverse, intermediate bracket 62 is pulled axially outwardly from the outer member 70 against the bias of the spring to provide sufficient width between the end brackets 28 to allow the other axial end of the elongated, tubular member 10 to be received by the opening 66 in the collar 64 of the other end bracket 28. The inner member 68 retracts under the bias of the spring into the outer member 70 when the end bracket 28 mounted on the inner member 68 is released by the user. Such structure retains the shade portion of the window shade antenna 2 to its mounting assembly 60.

The transverse, intermediate bracket 62 may include a plurality of holes 72 formed through the thickness thereof and spaced periodically along its longitudinal length. The holes 72 accept screws for securing the mounting assembly 60 to the frame of a window.

As stated previously, the window shade antenna 2 may include comparable mechanisms to that of an ordinary window shade for extending and retracting the shade portion of the antenna 2 over a window. One example is a combined spring-loaded pawl and circular ratchet mechanism situated on one axial end of the elongated, tubular member 10, or situated within the bore of the tubular member 10. Alternatively, a mechanical push button 74 located at one axial end of the elongated, tubular member 10 and accessible by a user may be mechanically linked to the pawl to release the pawl from catching on the teeth of the circular ratchet 76 to permit the shade portion of the window shade antenna 2 to be retracted and rolled back onto the tubular member 10, aided by the bias of a coiled spring 78 situated within the bore of the tubular member 10.

The window shade antenna 2 of the present invention is an unobtrusive, high gain, omni-directional, planar, flexible antenna that may be mounted on a window in a residential premises and function like an ordinary window shade in that it may be retracted and extended as desired by the user. When in use, the window shade antenna 2 may be extended so as to receive high definition television signals broadcast over the air. When not in use, or when it is desired that the window shade antenna 2 not cover the window on which it is mounted, the window shade antenna 2 may be retracted by the user such that the shade portion may be rolled up on the elongated, tubular member 10 forming part of the window shade antenna 2.

To facilitate a full understanding of the present invention, the window shade antenna disclosed previously will now be further described.

In one form of the present invention, a retractable antenna assembly mounted to a supporting structure, such as a window frame or a wall, includes a planar antenna 2 and a retraction mechanism 10. The planar antenna 2 is mechanically coupled to the retraction mechanism 10 and selectively retractable and extendable therefrom between a first position and at least a second position.

The retractable antenna assembly preferably includes a first end bracket 28 and a second end bracket 28, the first and second end brackets 28 being mountable to the supporting structure. The retraction mechanism 10 is operatively coupled to the first and second end brackets 28.

Preferably, the retraction mechanism 10 further includes an elongated member 10 having a first axial end and a second axial end disposed opposite the first axial end, the first axial end of the elongated member 10 being operatively coupled to the first end bracket 28 and the second axial end of the elongated member 10 being operatively coupled to the second end bracket 28. At least a portion of the planar antenna 2 is affixed to the elongated member 10.

In a preferred form, the elongated member 10 further includes a tubular sidewall extending between the first axial end and the second axial end of the elongated member 10. The tubular sidewall has an outer surface and defines an interior space extending at least partially along the axial length thereof. At least a portion of the planar antenna 2 is affixed to the outer surface of the elongated member 10.

The retractable antenna assembly also preferably includes a feed point 12, the feed point 12 being electrically coupled to the planar antenna 2, and a first cable 14, the first cable 14 having a first axial end and a second axial end disposed opposite the first axial end. The first axial end of the first cable 14 is electrically coupled to the feed point 12, and the first cable 14 is at least partially situated in the interior space defined by the tubular sidewall.

The retractable antenna assembly of the present invention may also include a preamplifier circuit 20. The preamplifier circuit 20 is in electrical communication with the first cable 14. In one form, the preamplifier circuit 20 is situated in the interior space defined by the tubular sidewall.

Also, the retractable antenna assembly of the present invention may include an AC-DC adapter 22, the AC-DC adapter 22 being electrically coupled to the preamplifier circuit 20 and an AC power source.

In yet another preferred form of the present invention, the retraction mechanism 10 of the retractable antenna assembly further includes a first spring assembly 78, the first spring assembly 78 being mechanically coupled to at least one of the first axial end and the second axial end of the elongated member 10. The first spring assembly 78 radially biases the elongated member 10 about the longitudinal axis of the elongated member 10 in at least a first direction. Preferably, the first spring assembly 78 is formed as a spring-loaded pawl and circular ratchet mechanism.

In yet another form of the retractable antenna assembly of the present invention, the retractable antenna assembly includes a mounting assembly 60, the mounting assembly 60 being mountable to the supporting structure. The retraction mechanism 10 is operatively coupled to the mounting assembly 60. Also, preferably, the mounting assembly 60 further includes an elongated intermediate member 62, the elongated intermediate member 62 having a first axial end and a second axial end disposed opposite the first axial end, and a first end bracket 28 and a second end bracket 28, each of the first end bracket 28 and the second end bracket 28 having a first portion and a second portion 64. The first portion of the first end bracket 28 is mounted to the elongated intermediate member 62 in proximity to the first axial end thereof, and the first portion of the second end bracket 28 is mounted to the elongated intermediate member 62 in proximity to the second axial end thereof. The second portions 64 of the each of the first end bracket 28 and the second end bracket 28 are operatively coupled to the retraction mechanism 10.

Furthermore, the elongated intermediate member 62 preferably includes at least a first telescoping member 70 and a second telescoping member 68. The second telescoping member 68 is at least partially receivable within the first telescoping member 70 and is selectively extendable therefrom and retractable therein to adjust the overall length of the elongated intermediate member 62.

Preferably, the elongated intermediate member 62 further includes a second spring assembly, the second spring assembly being mechanically coupled to the first telescoping member 70 and the second telescoping member 68. The second spring assembly biases the second telescoping member 68 in a direction toward the first end bracket 28.

In yet another preferred form of the retractable antenna assembly of the present invention, the planar antenna 2 further includes at least one antenna element 4, and a front covering layer 6 and a rear covering layer 8. The at least one antenna element 4 is situated between the front covering layer 6 and the rear covering layer 8. The front covering layer 6 has an outer surface, and the rear covering layer 8 has an outer surface. The outer surface of the front covering layer 6 faces away from the outer surface of the rear covering layer 8.

In a preferred form, the antenna element further includes a bottom antenna element segment 36 and a top antenna element segment 34 situated opposite the bottom antenna element segment 36. Each of the bottom antenna element segment 36 and the top antenna element segment 34 is formed as an elongated member 34, 36 having a first axial end and a second axial end situated opposite the first axial end. Furthermore, the antenna element 4 includes a first side antenna element segment 32 and a second side antenna element segment 32 situated opposite the first side antenna element segment 32. Each of the first side antenna element segment 32 and the second side antenna element segment 32 is formed as an elongated member 32 having a first axial end and a second axial end situated opposite the first axial end. The first side antenna element segment 32 and the second side antenna element segment 32 extend between the bottom antenna element segment 36 and the top antenna element segment 34. The first axial end of the bottom antenna element segment 36 is electrically coupled to the first axial end of the first side antenna element segment 32. The second axial end of the bottom antenna element segment 36 is electrically coupled to the first axial end of the second side antenna element segment 32. The first axial end of the top antenna element segment 34 is electrically coupled to the second axial end of the first side antenna element segment 32, and the second axial end of the top antenna element segment 34 is electrically coupled to the second axial end of the second side antenna element segment 32. Thus, the bottom antenna element segment 36, the top antenna element segment 34, the first side antenna element segment 32 and the second side antenna element segment 32 together define a rectangular loop antenna.

In yet another form of the retractable antenna assembly of the present invention, the antenna element 4 further includes a first outer sloping antenna element segment 40 and a second outer sloping antenna element segment 40. Each of the first outer sloping antenna element segment 40 and the second outer sloping antenna element segment 40 is formed as an elongated member 40 and has a proximate end and a distal end situated axially opposite the proximate end of the respective first and second outer sloping antenna element segments 40. The first and second outer sloping segments 40 mutually converge in a direction toward the proximate ends thereof such that the proximate ends of the first and second outer sloping segments 40 are electrically coupled together.

In yet a further form of the retractable antenna assembly of the present invention, the antenna element 4 further includes a first upper antenna element pattern segment 46 and a second upper antenna element pattern segment 46 situated opposite the first upper antenna element pattern segment 46. The antenna element 4 further includes a first lower antenna element pattern segment 48 and a second lower antenna element pattern segment 48. The first upper antenna element pattern segment 46 is electrically coupled to the first lower antenna element pattern segment 48, and the second upper antenna element pattern segment 46 is electrically coupled to the second lower antenna element pattern segment 48. Preferably, at least one of the first upper antenna element pattern segment 46, the second upper antenna element pattern segment 46, the first lower antenna element pattern segment 48 and the second lower antenna element pattern segment 48 is generally star-shaped.

It should be understood that the window shade antenna 2 of the present invention need not be mounted in a premises to cover a window; rather, the antenna 2 may simply function as a retractable antenna and not as a window shade, and may be mounted on a wall of the premises, away from or near a window, and may be extended on the wall when used to receive television signals, and retracted when not in use.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A retractable antenna assembly, the retractable antenna assembly being mountable to a supporting structure, the retractable antenna assembly comprising:
a planar antenna; and
a retraction mechanism;
wherein the planar antenna is mechanically coupled to the retraction mechanism and selectively retractable and extendable therefrom between a first position and at least a second position.

2. A retractable antenna assembly as defined by claim 1, wherein the retractable antenna assembly further comprises:
a first end bracket and a second end bracket, the first and second end brackets being mountable to the supporting structure;
wherein the retraction mechanism is operatively coupled to the first and second end brackets.

3. A retractable antenna assembly as defined by claim 2, wherein the retraction mechanism further comprises:
an elongated member having a first axial end and a second axial end disposed opposite the first axial end, the first axial end of the elongated member being operatively coupled to the first end bracket and the second axial end of the elongated member being operatively coupled to the second end bracket;
wherein at least a portion of the planar antenna is affixed to the elongated member.

4. A retractable antenna assembly as defined by claim 3, wherein the elongated member further comprises:
a tubular sidewall extending between the first axial end and the second axial end of the elongated member, the tubular sidewall having an outer surface and defining an interior space extending at least partially along the axial length thereof;
wherein at least a portion of the planar antenna is affixed to the outer surface of the elongated member.

5. A retractable antenna assembly as defined by claim 4, which further comprises:
a feed point, the feed point being electrically coupled to the planar antenna; and
a first cable, the first cable having a first axial end and a second axial end disposed opposite the first axial end;
wherein the first axial end of the first cable is electrically coupled to the feed point; and
wherein the first cable is at least partially situated in the interior space defined by the tubular sidewall.

6. A retractable antenna assembly as defined by claim 5, which further comprises:
a preamplifier circuit, the preamplifier circuit being in electrical communication with the first cable.

7. A retractable antenna assembly as defined by claim 6, wherein the preamplifier circuit is situated in the interior space defined by the tubular sidewall.

8. A retractable antenna assembly as defined by claim 6, which further comprises:
an AC-DC adapter, the AC-DC adapter being electrically coupled to the preamplifier circuit and an AC power source.

9. A retractable antenna assembly as defined by claim 3, wherein the retraction mechanism further comprises:
a first spring assembly, the first spring assembly being mechanically coupled to at least one of the first axial end and the second axial end of the elongated member;
wherein the first spring assembly radially biases the elongated member about the longitudinal axis of the elongated member in at least a first direction.

10. A retractable antenna assembly as defined by claim 9, wherein the first spring assembly is formed as a spring-loaded pawl and circular ratchet mechanism.

11. A retractable antenna assembly as defined by claim 1, wherein the retractable antenna assembly further comprises:
a mounting assembly, the mounting assembly being mountable to the supporting structure;
wherein the retraction mechanism is operatively coupled to the mounting assembly.

12. A retractable antenna assembly as defined by claim 11, wherein the mounting assembly further comprises:
an elongated intermediate member, the elongated intermediate member having a first axial end and a second axial end disposed opposite the first axial end; and
a first end bracket and a second end bracket, each of the first end bracket and the second end bracket having a first portion and a second portion;
wherein the first portion of the first end bracket is mounted to the elongated intermediate member in proximity to the first axial end thereof, and the first portion of the second end bracket is mounted to the elongated intermediate member in proximity to the second axial end thereof; and
wherein the second portions of the each of the first end bracket and the second end bracket are operatively coupled to the retraction mechanism.

13. A retractable antenna assembly as defined by claim 12, wherein the elongated intermediate member includes at least a first telescoping member and a second telescoping member, the second telescoping member being at least partially receivable within the first telescoping member and being selectively extendable therefrom and retractable therein to adjust the overall length of the elongated intermediate member.

14. A retractable antenna assembly as defined by claim 13, wherein the elongated intermediate member further comprises:
a second spring assembly, the second spring assembly being mechanically coupled to the first telescoping member and the second telescoping member;
wherein the second spring assembly biases the second telescoping member in a direction toward the first end bracket.

15. A retractable antenna assembly as defined by claim 1, wherein the planar antenna further comprises:
at least one antenna element; and
a front covering layer and a rear covering layer, the at least one antenna element being situated between the front covering layer and the rear covering layer, the front covering layer having an outer surface, and the rear covering layer having an outer surface, the outer surface of the front covering layer facing away from the outer surface of the rear covering layer.

16. A retractable antenna assembly as defined by claim 13, wherein the antenna element further comprises:
a bottom antenna element segment and a top antenna element segment situated opposite the bottom antenna element segment, each of the bottom antenna element segment and the top antenna element segment being an elongated member having a first axial end and a second axial end situated opposite the first axial end; and
a first side antenna element segment and a second side antenna element segment situated opposite the first side antenna element segment, each of the first side antenna element segment and the second side antenna element segment being an elongated member having a first axial end and a second axial end situated opposite the first axial end, the first side antenna element segment and the second side antenna element segment extending between the bottom antenna element segment and the top antenna element segment;
wherein the first axial end of the bottom antenna element segment is electrically coupled to the first axial end of the first side antenna element segment, the second axial end of the bottom antenna element segment is electrically coupled to the first axial end of the second side antenna element segment, the first axial end of the top antenna element segment is electrically coupled to the second axial end of the first side antenna element segment and the second axial end of the top antenna element segment is electrically coupled to the second axial end of the second side antenna element segment.

17. A retractable antenna assembly as defined by claim 16, wherein the bottom antenna element segment, the top antenna element segment, the first side antenna element segment and the second side antenna element segment together define a rectangular loop antenna.

18. A retractable antenna assembly as defined by claim 15, wherein the antenna element further comprises:
a first outer sloping antenna element segment and a second outer sloping antenna element segment, each of the first outer sloping antenna element segment and the second outer sloping antenna element segment being an elongated member and having a proximate end and a distal end situated axially opposite the proximate end of the respective first and second outer sloping antenna element segments, the first and second outer sloping segments mutually converging in a direction toward the proximate ends thereof such that the proximate ends of the first and second outer sloping segments are electrically coupled together.

19. A retractable antenna assembly as defined by claim 15, wherein the antenna element further comprises:
a first upper antenna element pattern segment and a second upper antenna element pattern segment situated opposite the first upper antenna element pattern segment; and
a first lower antenna element pattern segment and a second lower antenna element pattern segment;
wherein the first upper antenna element pattern segment is electrically coupled to the first lower antenna element pattern segment, and the second upper antenna element pattern segment is electrically coupled to the second lower antenna element pattern segment.

20. A retractable antenna assembly as defined by claim 19, wherein at least one of the first upper antenna element pattern segment, the second upper antenna element pattern segment, the first lower antenna element pattern segment and the second lower antenna element pattern segment is generally star-shaped.
